(19) United States
(12) Patent Application Publication
(10) Pub. No.: US 2020/0223270 A1
(43) Pub. Date: Jul. 16, 2020

(54) Active Camber Control Systems and Methods

(71) Applicant: Tenneco Automotive Operating Company Inc., Lake Forest, IL (US)

(72) Inventors: Brian A. KUNKEL, Dexter, MI (US); Thomas WATSON, Plymouth, MI (US)

(21) Appl. No.: 16/245,535

(22) Filed: Jan. 11, 2019

(51) Int. Cl. B60G 3/26

(52) U.S. Cl. CPC B60G 3/26; B60G 15/02

(57) ABSTRACT

A camber control system of a vehicle includes a camber actuator configured to adjust a camber angle of a wheel of the vehicle. A camber control module is configured to: determine a target camber angle for the wheel based on one or more operating parameters; and actuate the camber actuator based on the target camber angle, thereby adjusting the camber angle of the wheel toward the target camber angle.

### FIELD

The present disclosure relates to automotive suspension systems and more particularly to systems and methods for selectively adjusting camber of one or more wheels of a vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Shock absorbers are typically used in conjunction with automotive suspension systems or other suspension systems to absorb unwanted vibrations that occur during movement of the suspension system. In order to absorb these unwanted vibrations, automotive shock absorbers are generally connected between the sprung (body) and the unsprung (suspension/drivetrain) masses of a vehicle.

Camber of a wheel refers to the angle between the vertical axis of the wheel and the vertical axis of the vehicle when viewed from the front or rear of the vehicle. The tire of a wheel wears based on the camber of the wheel. Improper camber of a tire may cause pre-mature tire wear. Improper camber is typically corrected via a mechanic with specialized alignment equipment.

### SUMMARY

In a feature, a camber control system of a vehicle is described. A camber actuator is configured to adjust a camber angle of a wheel of the vehicle. A camber control module is configured to: determine a target camber angle for the wheel based on one or more operating parameters; and actuate the camber actuator based on the target camber angle, thereby adjusting the camber angle of the wheel toward the target camber angle.

In further features, the one or more operating parameters include a ride height of the vehicle.

In further features, the camber control module is configured to increase the target camber angle as the ride height decreases.

In further features, the camber control module is configured to decrease the target camber angle as the ride height increases.

In further features, the one or more operating parameters include a vehicle speed.

In further features, the camber control module is configured to: increase the target camber angle as the vehicle speed increases; and decrease the target camber angle as the vehicle speed decreases.

In further features, the one or more operating parameters include a road condition.

In further features, the one or more operating parameters include user input to the vehicle.

In further features, the camber control module is configured to selectively increase and selectively decrease the target camber angle based on the user input to the vehicle.

In further features, the one or more operating parameters include a yaw of the vehicle.

In further features, the camber actuator includes an electric motor that imparts linear motion.

In a feature, a camber control system of a vehicle is described. A first camber actuator is configured to adjust a first camber angle of a first wheel of the vehicle. A second camber actuator configured to adjust a second camber angle of a second wheel of the vehicle. A camber control module is configured to: determine a first target camber angle for the first wheel based on one or more operating parameters; determine a second target camber angle for the second wheel based on one or more of the operating parameters; and concurrently: actuate the first camber actuator based on the first target camber angle, thereby adjusting the first camber angle of the first wheel toward the first target camber angle; and actuate the second camber actuator based on the second target camber angle, thereby adjusting the second camber angle of the second wheel toward the second target camber angle.

In further features, the camber control module is configured to, based on the one or more of the operating parameters, set the first target camber angle to an angle that is different than the second target camber angle.

In a feature, a camber control method for a vehicle includes: by a camber actuator, selectively adjusting a camber angle of a wheel of the vehicle; determining a target camber angle for the wheel based on one or more operating parameters; and actuating the camber actuator based on the target camber angle, thereby adjusting the camber angle of the wheel toward the target camber angle.

In further features, the one or more operating parameters includes a ride height of the vehicle and the camber control method further comprises: increasing the target camber angle as the ride height decreases; and decreasing the target camber angle as the ride height increases.

In further features, the one or more one or more operating parameters includes a vehicle speed and the camber control method further comprises: increasing the target camber angle as the vehicle speed increases; and decreasing the target camber angle as the vehicle speed decreases.

In further features, the one or more operating parameters include a road condition.

In further features, the one or more operating parameters include user input to the vehicle.

In further features, the camber control method further includes selectively increasing and selectively decreasing the target camber angle based on the user input to the vehicle.

In further features, the one or more operating parameters include a yaw of the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an illustration of an example vehicle;

FIG. 2 is a functional block diagram of an example camber control system;

FIG. 3 is a partial view from in front of the vehicle including wheels with a neutral (zero) camber angle;

FIG. 4 includes an example illustration of wheels with an increased (positive) camber angle;

FIG. 5 includes an example illustration of wheels with an decreased (negative) camber angle;

FIG. 6 includes an example illustration of adjusting camber angle via lower control arms; and

FIG. 7 is a flowchart depicting an example method of controlling camber of a wheel.

In the drawings, reference numbers may be reused to identify similar and/or identical elements.

### DETAILED DESCRIPTION

Vehicles may be manufactured with a fixed camber angle that is not variable. The fixed camber angle may be selected by a vehicle manufacturer based on achieving a best possible tire performance and tire wear given all possible operating conditions. The fixed camber angle may, however, provide less than optimal tire performance under some operating conditions and/or less than optimal tire wear under some operating conditions.

According to the present application, a vehicle includes a camber control system that dynamically adjusts camber of one or more wheels of the vehicle based on one or more present operating conditions. The dynamic adjustment of camber based on the present operating condition(s) may increase tire performance and/or increase tire life.

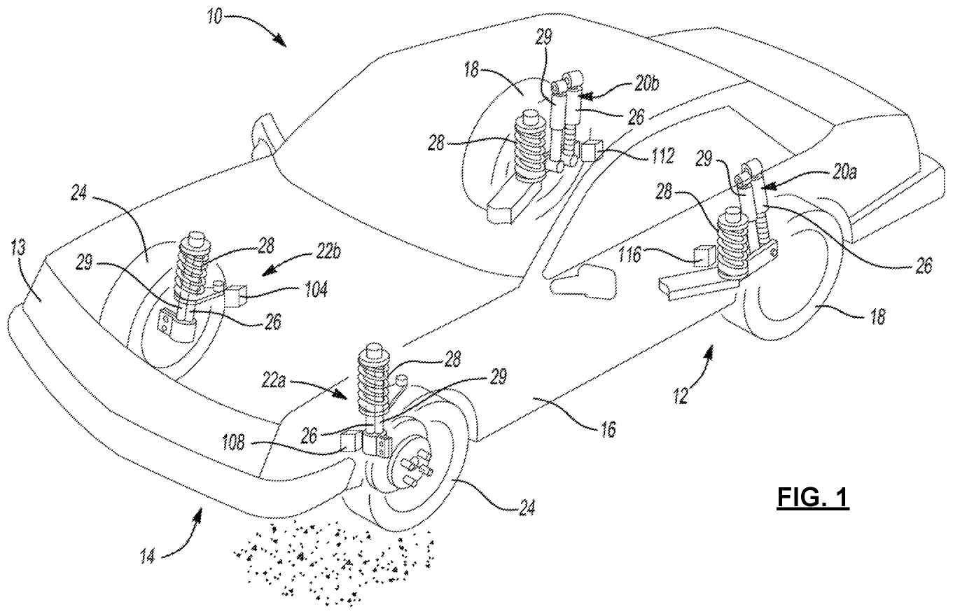

Referring to FIG. 1, a vehicle 10 including a rear suspension 12, a front suspension 14, and a body 16 is illustrated. The rear suspension 12 has a transversely extending rear axle assembly (not shown) adapted to operatively support the vehicle's rear wheels 18. The rear axle assembly is operatively connected to the body 16 by two damper systems 20a and 20b.

Similarly, the front suspension 14 includes a transversely extending front axle assembly (not shown) to operatively support the vehicle's front wheels 24. The front axle assembly is operatively connected to the body 16 by another two damper systems 22a and 22b.

A camber control system includes camber actuators 104 and 18 associated with the front wheels 24, respectively. The camber control system also includes camber actuators 112 and 116 associated with the rear wheels 18, respectively.

Each of the damper systems 20a, 20b, 22a, and 22b includes a damper 26, a helical coil spring 28. Each of the damper systems 20a, 20b, 22a, and 22b may also include an actuator 29. In the damper systems 22a and 22b, both the damper 26 and the actuator 29 may be arranged within the coil spring 28 in what may be referred to as a coil-over arrangement. In the damper systems 20a and 20b, the damper 26, the coil spring 28, and the actuator 29 are spaced apart from one another. Although FIG. 1 illustrates a coil-over arrangement for the front suspension 14 and a spaced apart arrangement for the rear suspension 12, different arrangements are possible, including arrangements where the same or similar damper systems are used at all four wheels (or corners) of the vehicle 10.

While the example of a passenger car is shown, the present application is also applicable to other types of vehicles. The present application is also applicable to other types of applications such as vehicles incorporating independent front and/or independent rear suspension systems. The term “damper system” as used herein refers to spring/damper systems in general and thus includes MacPherson struts.

The dampers 26 serve to dampen the relative motion of the unsprung portion of the front and rear suspension 14 and 12 and the sprung portion (i.e., the body 16) of the vehicle 10 by applying a damping force to the vehicle 10 that opposes the relative motion of the unsprung portion of the front and rear suspension 14 and 12 and the sprung portion (i.e., the body 16) of the vehicle 10. The coil springs 28 apply a biasing force to the sprung portion (i.e., the body 16) of the vehicle 10, which supports the sprung portion (i.e., the body 16) of the vehicle 10 on the unsprung portion of the front and rear suspension 14 and 12 in such a manner that bumps and other impacts are absorbed by the front and rear suspension 14 and 12.

The actuators 29 may be positioned with, next to, or near the dampers 26. When activated, the actuators 29 apply an active force on the vehicle 10 to soften or firm up the front suspension 12 and the rear suspension 14 depending on driver inputs, the speed of the vehicle 10, and road conditions. Generally, the active force operates in a substantially parallel direction to the biasing force of the coil springs 28. For example, during right-hand cornering, the actuators 29 of the damper systems 20a and 22a on the outside of the turn may be operated to apply an active force to the vehicle 10 to help keep the vehicle 10 level during the turn. In another example, during left-hand cornering, the actuators 29 of the damper systems 20b and 22b on the outside of the turn may be operated to apply an active force to the vehicle 10 to help keep the vehicle 10 level during the turn. The actuators 29 actively control body movements of the vehicle 10 independently of the damping forces generated by the dampers 26. In other words, the actuators 29 operate in parallel with the dampers 26 to control the ride and handling of the vehicle 10. The actuators 29 may also vary a ride height at each corner of the vehicle.

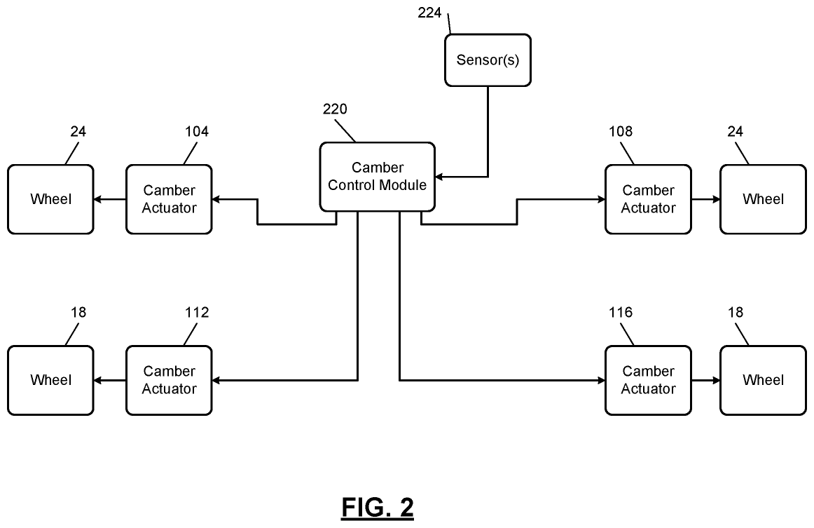

FIG. 2 is a functional block diagram of an example camber control system. A camber actuator is provided at each wheel. For example, the camber actuators 104 and 108 are provided at the front wheels 24. The camber actuators 112 and 116 are provided at the rear wheels 18. The camber actuators 104, 108, 112, and 116 adjust camber angles of the wheels, respectively. Camber actuators may only be provided with the front wheels 24, only the rear wheels 18, or both of the front wheels 24 and the rear wheels 18 as shown.

A camber control module 220 controls actuation of the camber actuators 104, 108, 112, and 116 based on one or more present operating parameters. The present operating parameters may be measured using sensors 224 or determined based on one or more other parameters. For example only, the camber control module 220 may determine target camber angles for the wheels, respectively, using one or more equations and/or lookup tables that relate the operating parameters to target camber angle. The camber control module 220 adjusts the camber actuators 104, 108, 112, and 116 to achieve the target camber angles, respectively.

Examples of the operating parameters may include, ride heights at the wheels of the vehicle, respectively, vehicle speed, yaw, road conditions, user input to the vehicle, and other operating parameters. The ride heights at the wheels may be measured using ride height sensors at the wheels, respectively. For example only, the camber control module 220 may increase the camber angle of a wheel as the ride height at that wheel decreases and vice versa. Decreasing ride height at a wheel may be indicative of an increase in load at that wheel. Increased load at a wheel may cause camber of the wheel to decrease. Increasing the camber angle may bring the camber angle closer to neutral and provide more even wear of the tire at that wheel.

Vehicle speed may be measured or determined, for example, based on one or more wheel speeds measured using one or more wheel speed sensors, respectively. For example, the camber control module 220 may increase the camber angle of one, more than one, or all of the wheels as the vehicle speed increases and vice versa. Downforce on the vehicle may increase as vehicle speed increases and vice versa. Increased downforce may cause camber of the wheel to decrease. Increasing the camber angle may bring the camber angle closer to neutral and provide more even wear of the tire at that wheel.

Yaw may be, for example, measured using a sensor. The camber control module 220 may increase the camber angle of one or more than one of the wheels on the outside of a turn or spin as the yaw increases and vice versa. For example, if the yaw indicates that the vehicle is turning or spinning clockwise, the camber control module 220 may increase the camber angle of one or both of the left side wheels as load on the left side wheels may be increased during turning or spinning clockwise. The camber control module 220 may additionally or alternatively decrease the camber angle of one or both of the right side wheels during turning or spinning clockwise as load on these wheels may be decreased. This may provide more even tire wear and increased vehicle stability. If the yaw indicates that the vehicle is turning or spinning counter-clockwise, the camber control module 220 may increase the camber angle of one or both of the right side wheels as load on the right side wheels may be increased during turning or spinning counter-clockwise. The camber control module 220 may additionally or alternatively decrease the camber angle of one or both of the left side wheels during turning or spinning counter-clockwise as load on these wheels may be decreased. This may provide more even tire wear and increased vehicle stability.

The road conditions may be measured, for example, using one or more optical devices. Alternatively, the road conditions may be determined based on one or more measured parameters, such as wheel speeds. For example, slippage of one or more wheels (e.g., as indicated by a difference between two or more wheel speeds being greater than a predetermined speed) while one or more other wheels may be indicative of a wet road or icy road. The camber control module 220 may, for example, increase the camber angle of one, more than one, or all of the wheels when the road conditions are a first condition (e.g., dry road). The camber control module 220 may additionally or alternatively decrease the camber angle of one, more than one, or all of the wheels when the road conditions are a second condition (e.g., wet or icy road). This may provide more even tire wear and increased vehicle stability.

User input may be received, for example, from an infotainment system of the vehicle, from a touchscreen display of the vehicle, or via one or more buttons, switches, etc. Additionally or alternatively, user input may be received wirelessly from a mobile device, such as a cellular phone or a tablet device. The camber control module 220 may increase the camber angle of a wheel in response to user input to increase the camber angle of the wheel. The camber control module 220 may decrease the camber angle of a wheel in response to user input to decrease the camber angle of the wheel. User input may be available for each different wheel.

User input may additionally or alternatively include a mode of operation of the vehicle, such as a sport mode, an economy mode, and a normal mode. The camber control module 220 may adjust the camber angles of one or more wheels based on the mode of operation. For example, the camber control module 220 may adjust the camber angle of a wheel based on a first predetermined camber angle when the mode of operation is a first mode (e.g., sport mode). The camber control module 220 may adjust the camber angle of a wheel based on a second predetermined camber angle when the mode of operation is a second mode (e.g., economy mode). The camber control module 220 may adjust the camber angle of a wheel based on a third predetermined camber angle when the mode of operation is a third mode (e.g., normal mode).

The camber actuators 104, 108, 112, and 116 may be any suitable type of camber actuator. For example, the camber actuators may include linear actuators or another suitable type of actuator, such as an actuator that imparts linear motion.

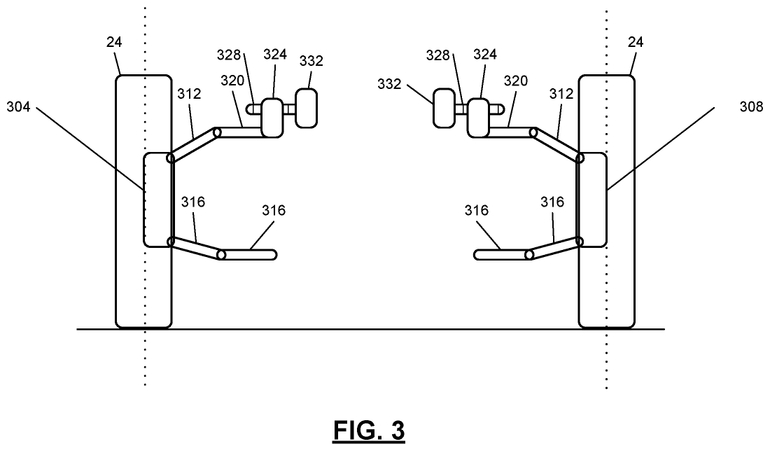

FIG. 3 includes a partial view from in front of the vehicle where the lowermost surface of each of the front wheels 24 contacts the ground. While the example of the front wheels 24 is shown, the present application is also applicable to the rear wheels 18 and both of the front wheels 24 and the rear wheels 18.

The front wheels 24 are coupled to the vehicle via hub assemblies 304 and 308. For example, threaded studs of the hub assemblies 304 and 308 may extend through apertures in rims of the front wheels 24. The rims may be secured to the hub assemblies 304 and 308 via lug nuts. Hub assemblies may also be referred to as wheel bearings. Upper and lower control arms 312 and 316 are connected to upper and lower portions of the hub assemblies 304 and 308.

One end of a linkage 320 is connected to the upper control arm 312. The other end of the linkage 320 includes a nut 324. The nut 324 includes an aperture with threads formed within the aperture. The threads are threaded onto a threaded rod 328. An electric motor 332 rotates the threaded rod 328. In this example, the camber actuator includes a power screw that translates rotational motion into linear motion. In another example, another type of actuator that imparts linear motion may be used, such as a worm screw jack or a linear actuator. The present application is also applicable to other types of camber actuators.

Rotation of the threaded rod 328 in one direction (e.g., clockwise) by the electric motor 332 causes the nut 324 to move outward and increase the camber angle of the front wheels 24. FIG. 4 includes an example illustration of the front wheels 24 with an increased (positive) camber angle.

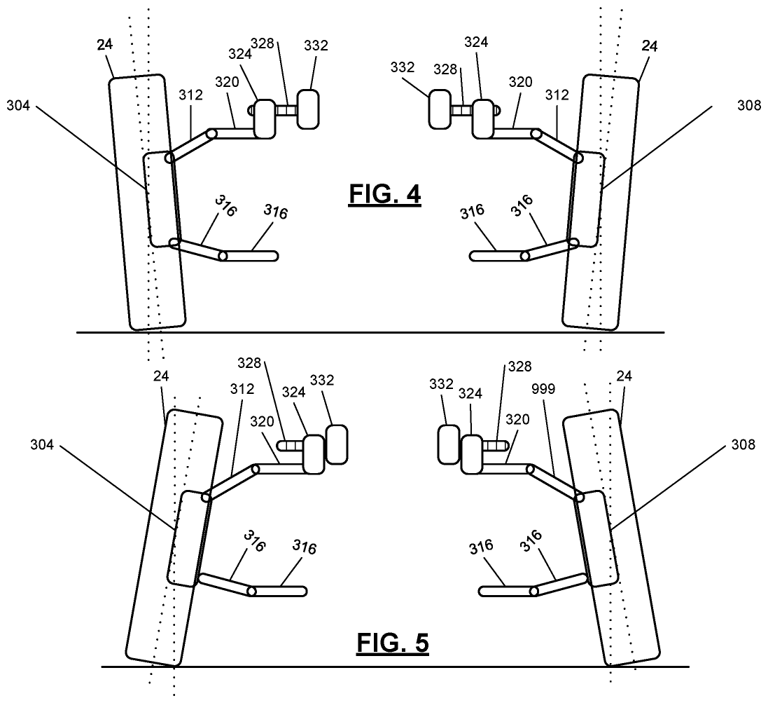

Rotation of the threaded rod 328 in the other direction (e.g., counter-clockwise) by the electric motor 332 causes the nut 324 to move inward and decrease the camber angle of the front wheels 24. FIG. 5 includes an example illustration of the front wheels 24 with a decreased (negative) camber angle. In FIG. 3, a neutral (0) camber angle is shown. While the example of the camber angles of both of the front wheels 24 is shown in the examples of FIGS. 3-5, the camber control module 220 may adjust the camber angles of the front wheels 24 independently.

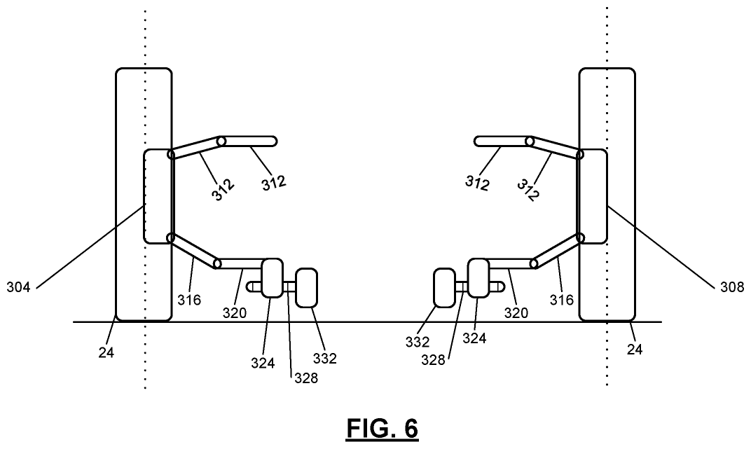

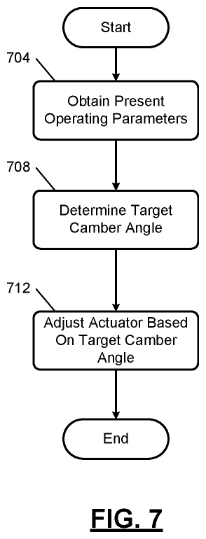

While the example of actuating the upper control arm 312 (and adjusting camber angle via adjusting the upper portion of the wheels) is shown in the examples of FIGS. 3-5, the present application is also applicable to adjusting camber angle via adjusting the lower portion of the wheels. For example, FIG. 6 includes an example diagram of the linkage attached to the lower control arms 316.

FIG. 7 includes a flowchart depicting an example method of controlling the camber angle of a wheel. While the example of one wheel is discussed, an instance of FIG. 7 may be performed (e.g., concurrently or sequentially) for each wheel having a camber actuator.

Control begins with 704 where the camber control module 220 obtains the present operating parameters, such as ride height, vehicle speed, road condition, user inputs, and/or one or more other operating conditions. At 708, the camber control module 220 determines the target camber angle for the wheel based on one or more of the present operating conditions. At 712, the camber control module 220 selectively adjusts the camber actuator of the wheel to adjust the camber angle of the wheel toward or to the target camber angle. The (present) camber angle of each wheel may be determined, for example, based on a position of the camber actuator of that wheel or based on an initial position of the camber actuator of that wheel and commands to the camber actuator of that wheel. While control is shown as ending after 712, control may return to 704. The camber control module 220 may begin with 704 each predetermined period, such as each X milliseconds, where X is a number greater than zero.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A camber control system of a vehicle, comprising:
a camber actuator configured to adjust a camber angle of a wheel of the vehicle;
a camber control module configured to:
determine a target camber angle for the wheel based on one or more operating parameters; and
actuate the camber actuator based on the target camber angle, thereby adjusting the camber angle of the wheel toward the target camber angle.

2. The camber control system of claim 1 wherein the one or more operating parameters include a ride height of the vehicle.

3. The camber control system of claim 2 wherein the camber control module is configured to increase the target camber angle as the ride height decreases.

4. The camber control system of claim 2 wherein the camber control module is configured to decrease the target camber angle as the ride height increases.

5. The camber control system of claim 1 wherein the one or more operating parameters include a vehicle speed.

6. The camber control system of claim 5 wherein the camber control module is configured to:
increase the target camber angle as the vehicle speed increases; and
decrease the target camber angle as the vehicle speed decreases.

7. The camber control system of claim 1 wherein the one or more operating parameters include a road condition.

8. The camber control system of claim 1 wherein the one or more operating parameters include user input to the vehicle.

9. The camber control system of claim 8 wherein the camber control module is configured to selectively increase and selectively decrease the target camber angle based on the user input to the vehicle.

10. The camber control system of claim 1 wherein the one or more operating parameters include a yaw of the vehicle.

11. The camber control system of claim 1 wherein the camber actuator includes an electric motor that imparts linear motion.

12. A camber control system of a vehicle, comprising:
a first camber actuator configured to adjust a first camber angle of a first wheel of the vehicle;
a second camber actuator configured to adjust a second camber angle of a second wheel of the vehicle; and
a camber control module configured to:
determine a first target camber angle for the first wheel based on one or more operating parameters;
determine a second target camber angle for the second wheel based on one or more of the operating parameters; and
concurrently:
actuate the first camber actuator based on the first target camber angle, thereby adjusting the first camber angle of the first wheel toward the first target camber angle; and
actuate the second camber actuator based on the second target camber angle, thereby adjusting the second camber angle of the second wheel toward the second target camber angle.

13. The camber control system of claim 12 wherein the camber control module is configured to, based on the one or more of the operating parameters, set the first target camber angle to an angle that is different than the second target camber angle.

14. A camber control method for a vehicle, comprising:
by a camber actuator, selectively adjusting a camber angle of a wheel of the vehicle;
determining a target camber angle for the wheel based on one or more operating parameters; and
actuating the camber actuator based on the target camber angle, thereby adjusting the camber angle of the wheel toward the target camber angle.

15. The camber control method of claim 14 wherein the one or more operating parameters includes a ride height of the vehicle and the camber control method further comprises:
increasing the target camber angle as the ride height decreases; and
decreasing the target camber angle as the ride height increases.

16. The camber control method of claim 14 wherein the one or more one or more operating parameters includes a vehicle speed and the camber control method further comprises:
increasing the target camber angle as the vehicle speed increases; and
decreasing the target camber angle as the vehicle speed decreases.

17. The camber control method of claim 14 wherein the one or more operating parameters include a road condition.

18. The camber control method of claim 14 wherein the one or more operating parameters include user input to the vehicle.

19. The camber control method of claim 18 further comprising selectively increasing and selectively decreasing the target camber angle based on the user input to the vehicle.

20. The camber control method of claim 14 wherein the one or more operating parameters include a yaw of the vehicle.
